(19) United States
(12) Patent Application Publication
(10) Pub. No.: US 2013/0273902 A1
(43) Pub. Date: Oct. 17, 2013

(54) SYSTEM AND METHOD FOR CONTROLLING WIRELESS DEVICE USE IN AN AREA

(71) Applicant: Fred Bolingbroke, Syracuse, UT (US)

(72) Inventor: Fred Bolingbroke, Syracuse, UT (US)

(21) Appl. No.: 13/646,260

(22) Filed: Oct. 5, 2012

Related U.S. Application Data
(63) Continuation-in-part of application No. 13/019,117, filed on Feb. 1, 2011.
(60) Provisional application No. 61/543,389, filed on Oct. 5, 2011.

(51) Int. Cl. H04W 76/02

(52) U.S. Cl. CPC H04W 76/02
USPC 455/422.1

(57) ABSTRACT

Method and systems of controlling the use of a wireless device within a vehicle are described. The system contains a control device containing a transmitter that emits a mimic signal having characteristics sufficiently similar to a wireless base station to cause the wireless device to register with the control unit. The control device contains a receiver that receives data from the wireless device and a controller coupled to the receiver and the transmitter. The controller responds to the receiver to receive attempts to establish a wireless communications session by the wireless device. The control device can also contain a tether unit that receives unique identification data from a wireless device and the controller can receive the unique identification data from the tether unit. Other embodiments are described.

### CROSS-REFERENCE TO RELATED APPLICATIONS

This patent application is a continuation-in-part of U.S. application Ser. No. 13/019,117, filed on Feb. 1, 2011, and claims priority of U.S. Provisional Application Ser. No. 61/543,389, filed Oct. 5, 2011, the entire disclosures of which are hereby incorporated by reference.

### FIELD

The present application relates to wireless communications systems. More particularly, the present application relates to controlling wireless device usage in an area.

### BACKGROUND

Wireless communications has become ubiquitous, with increasing numbers of individuals having and using wireless devices. Unfortunately, individuals do not always use these devices in a responsible manner. These devices can be particularly problematic when used in prisons, testing centers, at customs in airports, or in moving vehicles. For example, it is widely believed that the use of a cellular telephone while driving is a distraction to the driver that increases the likelihood of the driver being involved in an accident. Some states have gone so far as to pass laws prohibiting the use of cellular telephones while driving. Regardless of the risks and prohibitions, many individuals continue to use their cellular telephones in restricted locations and while driving.

### SUMMARY

This application describes a method and a system of controlling the use of a wireless device within a specific area, such as within a vehicle. The system contains a control device (or control unit) that manages use of a wireless device within that area. The control device contains a transmitter that can be configured to emit a mimic signal having characteristics sufficiently similar to a wireless base station to cause the wireless device to register with the control device. The control device can also contain a receiver that can be configured to receive data from the wireless device. The control device can also contain a controller coupled to the receiver and the transmitter, where the controller can be responsive to the receiver to receive attempts to establish a wireless communications session by the wireless device. The control device can also contain a tether unit that can be configured to receive unique identification data from a wireless device. The controller can be configured to receive the unique identification data from the tether unit. The transmitter can be responsive to the controller to perform actions to selectively establish a wireless communications session between the wireless device and an external network when the wireless device has the same unique identification data as the unique identification data received by the control device from the tether interface. With such a system, a mimic signal can be emitted from the control device. The mimic signal can have characteristics sufficiently similar to a wireless base station to cause the wireless device to register with the control device. The control device can receive attempts to initiate wireless communication session from the wireless device, and can selectively allow a wireless communications session between the wireless device and an external network when the wireless device is connected to the vehicle via a tether unit.

### BRIEF DESCRIPTION OF THE DRAWINGS

The following description can be better understood in light of the Figures, in which:

FIG. 1 is a block diagram of some embodiments of a system providing control of a wireless device;

FIG. 2 is a protocol diagram illustrating some embodiments of a message exchange between a wireless device and a control unit showing wireless device registration with the control unit;

FIG. 3 is a block diagram of some embodiments of a system providing control of a wireless device within a vehicle;

FIG. 4 is a block diagram of other embodiments of another system providing control of a wireless device within a vehicle;

FIG. 5 is a block diagram showing still other embodiments of system for providing control of a wireless device within a vehicle;

FIG. 6 is a block diagram showing yet other embodiments of another system for providing control of a wireless device within a vehicle;

FIG. 7 is a protocol diagram illustrating some embodiments of a message exchange between a wireless device and a control unit showing the control unit allowing calls; and

FIG. 8 is a block diagram illustrating some embodiments of a tether unit.

The Figures illustrate specific aspects of methods and systems of controlling the use of a wireless device within an area. Together with the following description, the Figures demonstrate and explain the principles of the methods and structures produced through these methods. In the drawings, the thickness of layers and regions are exaggerated for clarity. The same reference numerals in different drawings represent the same element, and thus their descriptions will not be repeated. As the terms on, attached to, or coupled to are used herein, one object (e.g., a material, a layer, a substrate, etc.) can be on, attached to, or coupled to another object regardless of whether the one object is directly on, attached, or coupled to the other object or there are one or more intervening objects between the one object and the other object. Also, directions (e.g., above, below, top, bottom, side, up, down, under, over, upper, lower, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements.

### DETAILED DESCRIPTION

The following description supplies specific details in order to provide a thorough understanding. Nevertheless, the skilled artisan would understand the circuit operation and methods for making and using such circuits can be implemented and used without employing all of the described details. Indeed, the devices and associated methods can be placed into practice by modifying the illustrated devices and associated methods and can be used in conjunction with any other apparatus and techniques conventionally used in the industry. For example, while description refers to vehicles, it could be modified for other areas, such as prisons, testing centers, and/or at secure locations (such as custom screening areas in airports).

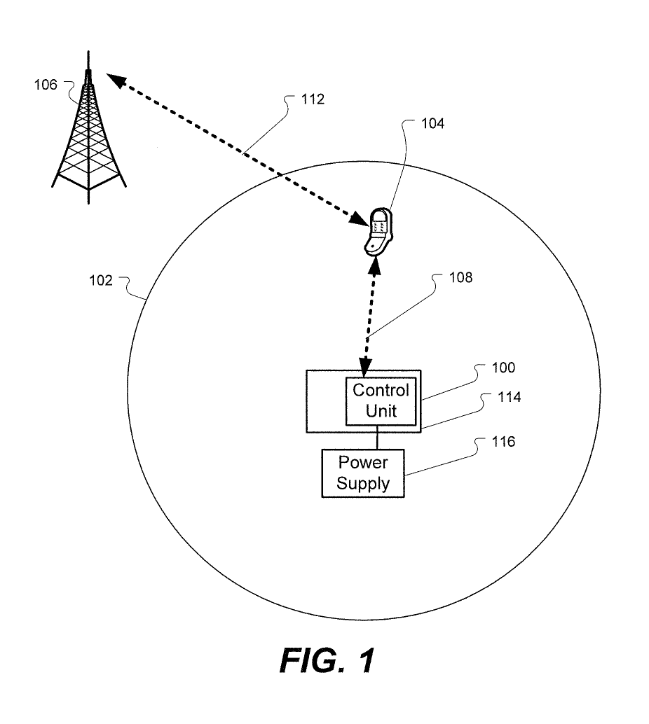

The Figures show some embodiments of methods and systems for controlling the use of a wireless device within an area. FIG. 1 provides one illustration of a system for controlling wireless device usage in an area 102. In some embodiments, the area 102 can include any desired geographic area or location that has—or is part of—a wireless network 106 (as one example of an external communications network). In other embodiments, the area 102 include any area in which wireless communication can be controlled or restricted. The area can be a room in a building, a building, an outdoor location, the interior of a vehicle, a portion of those areas, or any combination thereof. In some embodiments, the area 102 comprises the interior of a vehicle. The vehicle may include automobiles, trucks, motorcycles, bicycles, boats, aircraft, or the like. The wireless network 106 can be any known wireless network including, for example, a cellular network, a personal communications services network, a WiFi network, a wireless internet network, or the like.

As depicted in FIG. 1, a control unit (or control device) 100 can be installed in, placed in, or moved into an area 102. The control unit 100 can, in some configurations, be disposed within a housing 114 and coupled to a power supply 116. The control unit 100 can control the usage of a wireless device 104 within the area 102, as described herein. The wireless 104 device can be any wireless communication device, including a cellular telephone, personal data assistant, a tablet computer, a laptop computer, a game system, or combinations thereof.

The power supply 116 can be an external or internal power supply. In portable embodiments of the control unit 100, the power supply can be internal, such as one or more batteries or one or more battery packs. Portable control units can also be at least partially reliant on an external power supply, such as a power outlet. Thus, the control unit can have a power cord for connecting to an external power supply. In those embodiments when it is used within a vehicle to limit the use of a wireless device 104 therein, the control unit can be coupled to the power system of the vehicle, such as the battery. Thus, in some configurations, the control unit 100 can be configured to be powered by a 12 volt DC power supply, or any other known vehicle power supply. In other configurations, the control unit can be configured to be powered by an AC power supply, such as a 120 volt power supply.

The control unit 100 can be configured to emit a mimic signal. In some embodiments, the mimic signal can be substantially limited to the area or a selected region within the area 102. For example, the transmission power of the control unit 100 can be selected to help ensure that the signal strength of the mimic signal is below a predetermined level outside of the area 102. In some configurations, the control unit 100 can be configured to transmit an effective mimic signal within a radius of between about 5 feet to about 50 feet. In other configurations, the control unit 100 can be configured to transmit a mimic signal to a range greater than about 50 feet, such as up to about 75 feet, about 100 feet, about 200 feet, about 500 feet, about 1000 feet, or more than about 1000 feet. In yet other configurations, the control unit 100 can be configured to limit the transmission of an effective mimic signal to no more than a radius of about 5 feet to about 50 feet, or the other above-listed transmission ranges. In even other configurations, this limit can be any combination or sub-range of these numbers. Control over the transmission power can include an automatic or manual adjustment feature that controls the transmission power of the control unit. Non-limiting examples of an adjustment feature include a rotatable knob, a switch, and a keypad.

In some embodiments, the signal strength of the mimic signal emitted by the control unit 100 can be set to a level where it is higher than the signal strength of any external networks within an area (e.g. a room, building, open area, a vehicle, etc.), but can be substantially contained within the area. For example, a mimic signal can be set at a sufficiently low level outside the area so that wireless devices outside the area do not attempt to register with the control unit that is substantially contained therein. As another example, a mimic signal can be substantially contained within the area if the mimic signal is at a sufficiently low level outside of the area so that degradation to wireless communications of wireless devices outside the vehicle is less than a predetermined amount. This predetermined amount can be, for example, 3 dB, 1 dB, 0.5 dB, or any other value.

The signal strength of the mimic signal can be determined by both the power output of a transmitter of the control unit 100 and the antenna gain of an antenna of the control unit. As antennas are directional, the gain pattern of the antenna can be tailored to help contain the mimic signal within the desired portions of the area 102. For example, for an antenna mounted near an exterior surface of the area 102, the antenna gain pattern can be oriented to radiate most of the power toward the interior of the area while minimizing power radiated toward the exterior of the area. If desired, multiple antennas can be used in some configurations. For example, an antenna on a northern wall of a room can provide mimic signal coverage of the northern portion of the room, and an antenna on a southern wall of a room can provide mimic signal coverage of the southern portion of the room. In some configurations, the coverage of the mimic signal can be the entire portion of the room or limited to be less than the entire room. In other configurations, the mimic signal can be directed to a specific portion of an area, such as near a customs desk in an airport, or other intended area. In the embodiments where the area 102 includes a vehicle, an antenna near the forward portion of the passenger compartment of a vehicle can provide mimic signal coverage of the driver and front passenger seats, and an antenna near the rear portion of the passenger compartment can provide mimic signal coverage of the rear passenger seats. If desired, the coverage of the mimic signal can be limited to be less than the entire interior of the vehicle. For example, the mimic signal can be substantially contained within a limited area that covers the area of the driver, thereby allowing wireless device usage by passengers.

The mimic signal emitted from the control unit 100 can be configured to be sufficiently similar to a wireless base station to cause a wireless device 104 that is within the area 102 to register with the control unit rather than with the external wireless network 106. For example, as described herein, the mimic signal can have a similar signal and data format as a base station pilot or beacon signal that is emitted from the external wireless network. The mimic signal can, in other embodiments, have a stronger signal strength within the vehicle as compared to the signal strength of the external wireless network. Accordingly, the wireless device 104 can establish a communications link 108 with the control unit rather than the external network 106. Thus, when the wireless device attempts to initiate a wireless communications session, it will communicate with the control unit 100 rather than the external network. Thus, the control unit 100 will receive attempts to initiate wireless communications from the wireless device.

The control unit 100 can have various message exchange protocols for communicating with the wireless device 104 by which the control unit 100 can prevent and allow calls from the wireless device. Examples of such message exchange protocols are described and illustrated in U.S. patent application Ser. No. 13/019,117, filed Feb. 1, 2011, the entire disclosure of which is incorporated herein by reference.

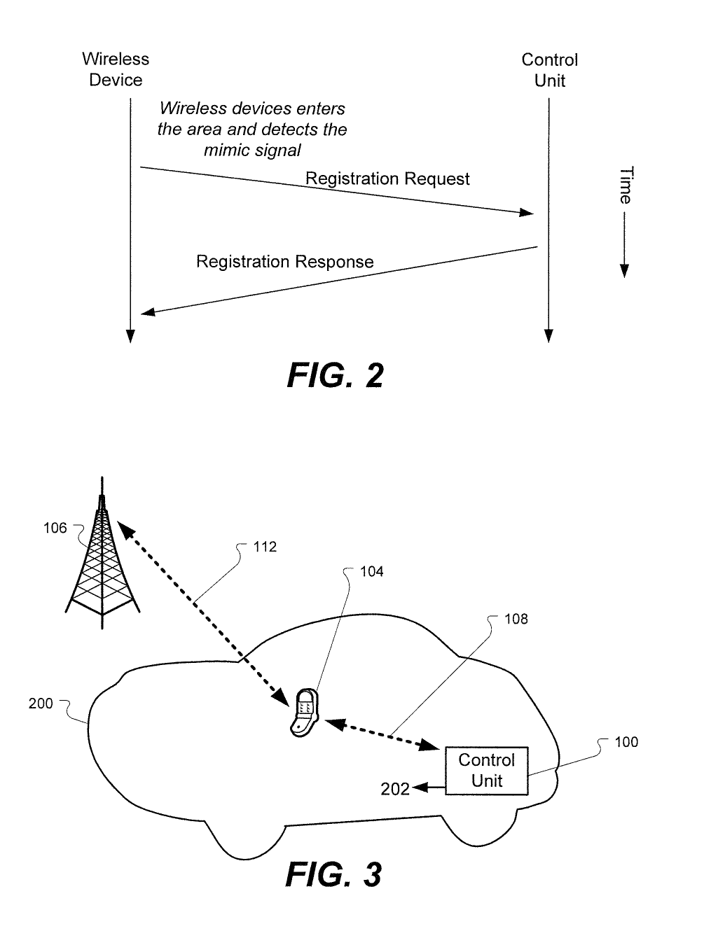

FIG. 2 illustrates a protocol diagram showing one example of message exchanges between a wireless device 104 and the control unit 100 which can occur when the wireless device is first brought into the area. With time shown in the vertical axis, the wireless device and control unit are each represented by vertical lines, and message flow between the wireless device and the control unit are shown as diagonal lines (the lines are sloped to suggest the time delays associated with wireless signal propagation and message processing). Annotations shown in italics between the messages describe other activities which may occur within the wireless device or control unit (e.g., actions triggered by reception of a message, or actions which trigger the transmission of a message). When the wireless device enters the area, it can detect the mimic signal. Because the mimic signal is stronger (within the area 102) than the external network 106, the wireless device will attempt to register with the control unit 100. Thus, the wireless device will send a registration request message to the control unit. The control unit can respond with a registration response message. At this point, the wireless device is now associated with the control unit rather than the external network. Thus, the control unit (rather than the external network) will receive call requests from the wireless device, and the control unit can determine whether or not to allow the calls to go through to the external network 106.

Various ways of configuring and operating the control unit 100 are possible. In some embodiments, the control unit can be configured to operate as follows. When the wireless device 104 attempts to initiate a call, it will typically send a set-up request to the base station to which it is registered. Hence, when the wireless device is inside the area controlled by the control unit, it will register with the control unit. The wireless device will then send the set-up request to the control unit. Normally, the wireless device expects a set-up assignment to be sent back from the base station, at which point the wireless device proceeds with the call, typically using an assigned frequency or code channel specified by the base station. As previously explained, different messages and sequences of messages can be exchanged between the control unit and the wireless device for preventing and allowing communications. The specifics of such schemes can depend on the particular protocols supported by the external communications network.

As shown in the embodiments shown in FIG. 3, the control unit 100 can be placed or installed within a vehicle 200 to control the use of one or more wireless device therein. The methods, systems, and devices described in reference to the use of control unit within a vehicle, as described herein, can also be applied to methods, systems, and devices for using a control unit within an area outside of a vehicle.

As shown in FIG. 3, the control unit 100 can have an interface 202 to the vehicle to allow the control unit to obtain information from the vehicle 200. The information can be used to determine the operational mode of the vehicle. For example, the information can include whether the vehicle's engine is running, what gear the vehicle is in, whether the vehicle is moving, a speed at which the vehicle is moving, or combinations thereof. This information can be used by the control unit to determine whether the vehicle is in motion, and when (and if) to allow the wireless device 104 to initiate or receive wireless communications sessions. In some configurations, the control unit 100 can use a Global Positioning System (GPS) receiver to determine when the vehicle is in motion. For example, the GPS receiver can be interfaced to the control unit to provide movement data to the control unit.

The control unit 100 can selectively allow the wireless device 104 to engage in communication sessions with the external network 106. The communication sessions can include any known communication using the wireless device 104 including a voice call, a data session, a text message, an email message, internet communications, a VOIP call, or combinations thereof. The control 100 unit can also enable or disable calls based on one or more predefined rules, including whether the vehicle is powered on or not, whether the vehicle is in motion or not, what telephone number is being called, or combinations thereof. In some embodiments, any desired communication can be prevented whenever the vehicle is moving (e.g., vehicle speed above a threshold of zero or other amount), whenever the vehicle is in a gear capable of allowing movement (e.g., reverse, drive, 1^{st} gear, etc.), and/or when the vehicle engine is powered on. In other embodiments, any desired communication can be allowed when the vehicle is stopped, when the vehicle is in a non-moving gear (e.g., park), and/or when the vehicle engine is off. For example, voice calls can be prevented when the vehicle is moving by turning the mimic signal on, and calls can be allowed when the vehicle is stopped by turning the mimic signal off.

Since moving vehicles frequently stop at stop signs, stop lights, yield signs, train tracks, etc., it may be desirable to prevent the initiation of voice calls and other communication sessions while the vehicle is stopped since these calls may be continued after the vehicle again begins to move. Accordingly, in some embodiments, any communication can be prevented whenever the vehicle is powered on, regardless of the speed of the vehicle or whether it is in a moving or non-moving gear.

In some embodiments, the control unit may be configured to intercept and terminate communication sessions whenever the vehicle is powered on or moving. Naturally, some users may seek to work around these limitations by initiating a communication session when it is permitted (e.g. just prior to entering the vehicle or while the vehicle is temporarily stopped) and continuing the communication session when such is prohibited (e.g. while driving). Accordingly, the control unit can be configured to recognize the communication session, intercept, and/or terminate the communication session. In some configurations, such interception includes registering with the wireless device, as previously described. By intercepting and/or terminating communication session, the control unit can also control other such work-arounds. For example, a user may attempt to work around the system by making a permitted communication session (e.g. a 911 voice call) then terminative the communication session before it goes through and quickly initiating an impermissible communication session. When such occurs, the control unit can intercept and terminate the communication session.

In some embodiments, any desired communication can be allowed based on the destination of the call regardless of other rules (i.e., the vehicle movement or engine status). For example, voice calls to emergency telephone numbers (e.g., 911) can be allowed at any time. As another example, voice calls to a list of different pre-defined telephone numbers can be allowed at any time. As another example, data sessions to pre-defined destinations (e.g., Internet Protocol address, email address, etc.) can be allowed at any time. The pre-defined list of numbers can be specified by government authorities, a vehicle owner (e.g., the owner of a corporate fleet), or any other person or entity.

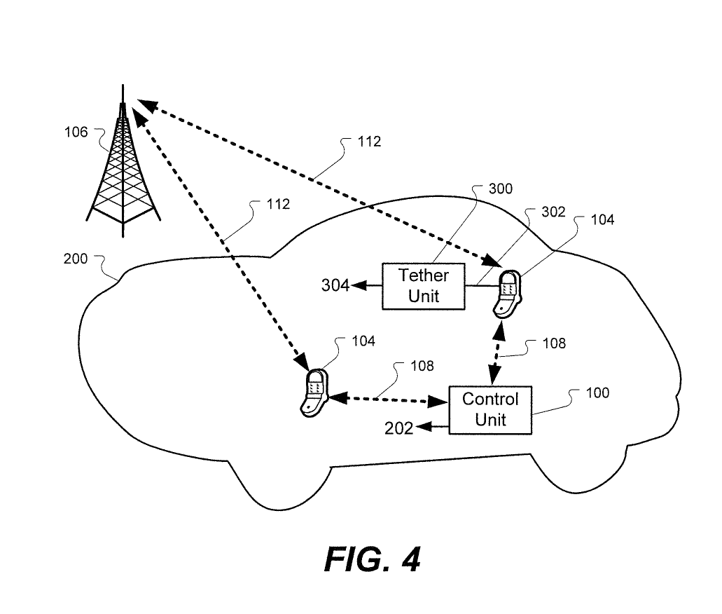

FIG. 4 shows some embodiments of methods and systems of allowing the use of a wireless device 104 within a vehicle 200 having a control unit 100 when the wireless device is connected to a tether unit 300. The tether unit 200 can include a cable 302 that connects the wireless device 104 and the vehicle 200. The vehicle 200 can have one or more tether connectors (e.g. a plug or receptacle) located within the vehicle and away from the driver seat. Representative locations for a tether connector can be on the passenger door, on the passenger head rest, on the passenger side of the front console, on the back seat, on a back door, on a roof section, on a post of the vehicle, or combinations thereof.

In some configurations, the length of the cable can be limited. By limiting the length of the cable 302, a wireless device 104 connected to the tether unit 300 will not reach a person in the driver seat. For instance, the tether lengths can range between about 10 inches to about 15 inches, about 15 inches to about 20 inches, about 20 inches to about 30 inches, 30 inches to about 40 inches, about 40 inches to about 50 inches, or more than about 50 inches. In some instance, the length is between about 12 inches to about 24 inches. In a particular instance, the length is about 15 inches. In still other instances, the length of the tether can be any suitable combination or sub-range of these amounts. It will be understood that the length of the tether unit can accommodate the placement of the tether connector and the placement of seats within the vehicle in order to prevent a wireless device from reaching the driver of the vehicle, but permitting it to reach other passengers in the vehicle.

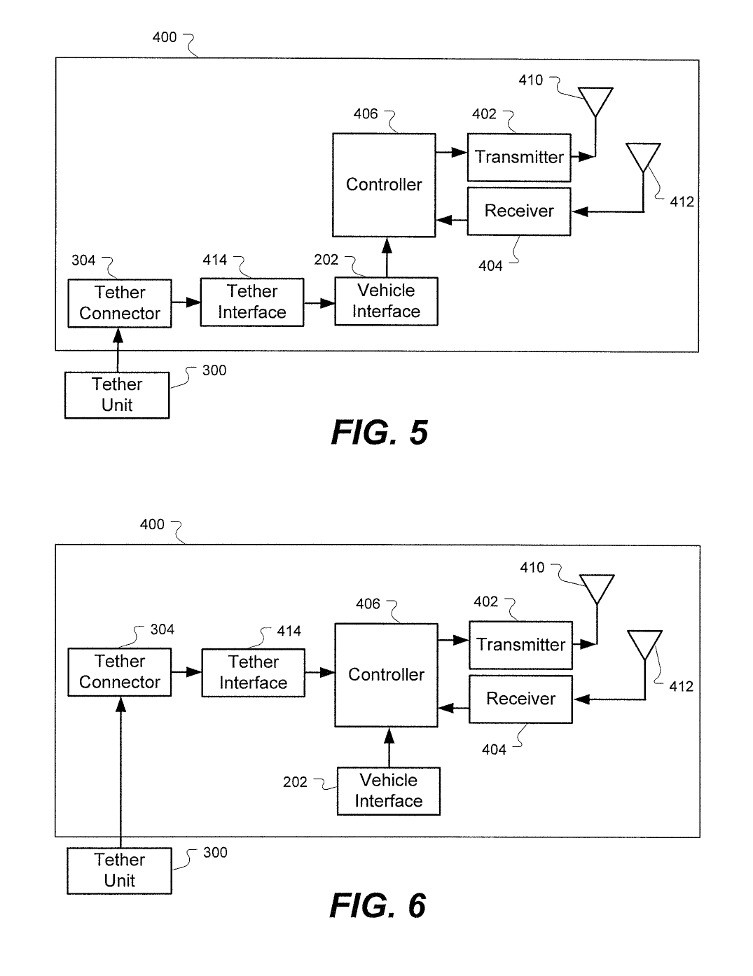

FIG. 5 provides a block diagram of some embodiments of a control unit 400 that can be used in place of—or in addition to—the control unit 100 in FIG. 1. The control unit 400 can be configured to connect a controller 406 to a tether unit 300. The control unit 400 can include a transmitter 402, a receiver 404, a controller 406, a vehicle interface 202, a tether interface 414, a tether connector 304, and one or more antennas 410, 412. The transmitter 402 can be used to transmit a mimic signal, as described herein.

The transmitter 402 can, for example, include any known type of transmitter, such as a base station transmitter. Accordingly, the transmitter can transmit a paging channel. The paging channel can be compliant with any communication specification and/or standard. In some embodiments, the paging channel can comply with the CDMA2000 system specifications (also referred to as “3G cellular” or “CDMA cellular”). There exist any number of variants of the CDMA2000 standard in operation around the world, and the transmitter 402 can be compliant with one or more of those existing standards. As a particular example, the system can be compliant with CDMA2000 1x, CDMA2000 1xEV-DO (e.g., Rel. 0, Rev. A, or Rev. B) and CDMA 2000 1xEV-DV. In some cases, compliance with one standard can also provide backwards compatibility with earlier standards. As another example, the paging channel can be compliant with any emerging cellular standard that is still under development, such as CDMA2000 3x and the 3rd Generation Partnership Project 2 (3GPP2) Long Term Evolution (LTE) or 4G cellular wireless network standards. In other embodiments, the paging channel can be compliant with the UMTS system specifications (also referred to as “3G cellular” or “WCDMA”). Like CDMA2000, there are a number of variants of the UMTS system and the transmitter 402 can be compliant with one or more of these standards, such as for example UMTS Release 99, any of UMTS Release 4-9, or standards still under development such as the 3^{rd} Generation partnership Project (3GPP) LTE.

The transmitter 402 can transmit additional logical and physical channels (known as forward channels) in addition to the paging channel. For example, to produce a CDMA2000 mimic signal, a pilot channel can also be transmitted. As another example, to produce a UMTS mimic signal, the paging channel and a broadcast control channel can be transmitted within a primary common control physical channel.

The transmitter 402 can be configured to transmit the mimic signal using similar signal formats and frequency allocations as used by the cellular network (or networks) in the geographic area in which the vehicle is expected to operate. For example, if the vehicle is expected to operate within the U.S., the mimic signal can use signal formats and frequency allocations corresponding to U.S. cellular systems.

In some situations (e.g., the U.S.), there may be multiple cellular networks operating using different frequency allocations and/or signal formats. In such a situation, the control unit 400 can include multiple transmitters 402. The multiple transmitters can be configured to transmit a plurality of signals corresponding to multiple cellular system types. For example, one transmitter can transmit CDMA2000 signals and another transmitter can transmit UMTS signals. As another example, multiple transmitters can be used to transmit signals in multiple frequency bands (e.g., within the 800 MHz cellular band, within the 1800-1900 MHz personal communications bands, or within other bands).

The transmitter 402 can be coupled to the antenna(s) 410 to allow for radiation of the mimic signal emitted by the transmitter 402. As mentioned above, the signal strength of the mimic signal emitted by the transmitter 402 can be set to a level where it is higher than the signal strength of external networks within the vehicle, but can be substantially contained within the vehicle.

The receiver 404 can receive data from wireless devices within the vehicle or within a limited area within the vehicle. The receiver can be configured to receive a random access channel (e.g., the CDMA2000 RACH or the UMTS RACH). The receiver can also be configured to receive other channels (known as reverse channels). In some embodiments, the receiver can comprise a base station receiver that can be coupled to the antenna(s) 412. Alternatively, the transmitter 410 and receiver 404 can share a same antenna (not shown), for example, using a diplexer. If desired, multiple receivers can be included in the system. For example, multiple receivers corresponding to different cellular system standards can be used. As another example, a receiver compatible with the Bluetooth standard can be included to allow detection of when a Bluetooth link is active.

The controller 406 can be configured to interface with the transmitter 402 and receiver 404, as shown in FIG. 5. The controller 406 can provide signal parameters (e.g., transmit on/off, transmit power level, transmit modulation, transmit signal format, etc.) and data for transmission (e.g., layer 2 messages) to the transmitter. The controller 406 can also provide signal parameters (e.g., receive on/off, receive modulation, receive signal format, etc.) to the receiver. The controller 406 can also accept data received (e.g., layer 2 messages) from the receiver.

The controller 406 can implement logic to implement various signaling protocols between the control unit 400 and a wireless device. For example, the vehicle interface 202 can provide the controller 406 with information sufficient to determine the operational mode of the vehicle in which the control unit is installed. In some embodiments, the vehicle interface can be an electronic interface to the vehicle engine controller. The vehicle interface can provide information such as vehicle speed, vehicle gear, vehicle engine status (on/off, etc.), or combinations thereof. The controller can use the operational mode of the vehicle to determine whether to allow communications sessions between the wireless device and the external network. For example, the control unit can selectively enable wireless communications sessions according to one or more predefined rules. The control unit can be responsive to messages received from the receiver attempting to establish a call by sending signal parameters and/or data to the transmitter to selectively enable calls, as described herein.

In some embodiments, the controller 406 can include a computer system that can implement processing logic. The computer interface of the computer system can include computer-executable instructions to execute functions to implement logical operations. The computer system can include various input/output interfaces. The computer system can be used to implement a process for controlling wireless device usage within a vehicle in distinct software modules, such as an initialization module, a registration module, and a call management module. Examples of such computer systems, computer executable instructions, logical operations, input/output interfaces, and software modules are described and illustrated in U.S. patent application Ser. No. 13/019,117, filed Feb. 1, 2011, the entire disclosure of which is incorporated herein by reference.

As shown in FIG. 5, the control unit 400 can include a tether interface 414 that connects a tether connector 304 of a tether unit to the vehicle interface 202. In some embodiments, the tether interface can comprise an electronic interface to the tether unit. The tether interface can provide information such as wireless device identification, whether a wireless device is connected to a tether unit, or combinations thereof. With such a configuration, a tether unit 300 can be in electronic communication with the controller 406. In some embodiments, the tether unit or the wireless device can be configured to transmit identification data unique to the wireless device to the controller. For instance, the identification data of a mobile phone can be its international mobile equipment identity (IMEI). The identification data can be communicated via the tether interface, via the vehicle interface to the control unit, where it can be stored. When the wireless device connected to the tether unit attempts to engage in a communication session, the control unit can receive the identification data with the attempt, compare this identification data with the stored data, recognize the device as a tethered device, and allow the call. In some configurations, the control unit can periodically or in real-time verify that the wireless device is still connected to the tether interface via the tether unit. If the control unit determines that the wireless device has been disconnected from the tether interface or the tether unit, the control unit can terminate a communication session engaged in by the wireless device.

In the embodiments shown in FIG. 6, the tether interface 414 can be connected directly to the controller, rather than through the vehicle interface 202. Such variations in the configuration of the control unit 400 may be vehicle dependent. Other configurations may be incorporated into the control unit. For example, the tether interface can be incorporated into the vehicle interface 202 of the control unit. When the control unit 400 is used outside of a vehicle, such as in a room or other area, a tether unit 300 can be directly coupled to the control unit. In such instances, the length of the tether unit can be longer than it is with tether units used in vehicles. Representative lengths of such a tether unit can be up to about 5 feet, up to about 10 feet, up to about 15 feet, up to about 20 feet, up to about 30 feet, or even greater than about 30 feet depending on the size needed of the tether unit. In other embodiments, the tether unit can be wirelessly connected to the control unit.

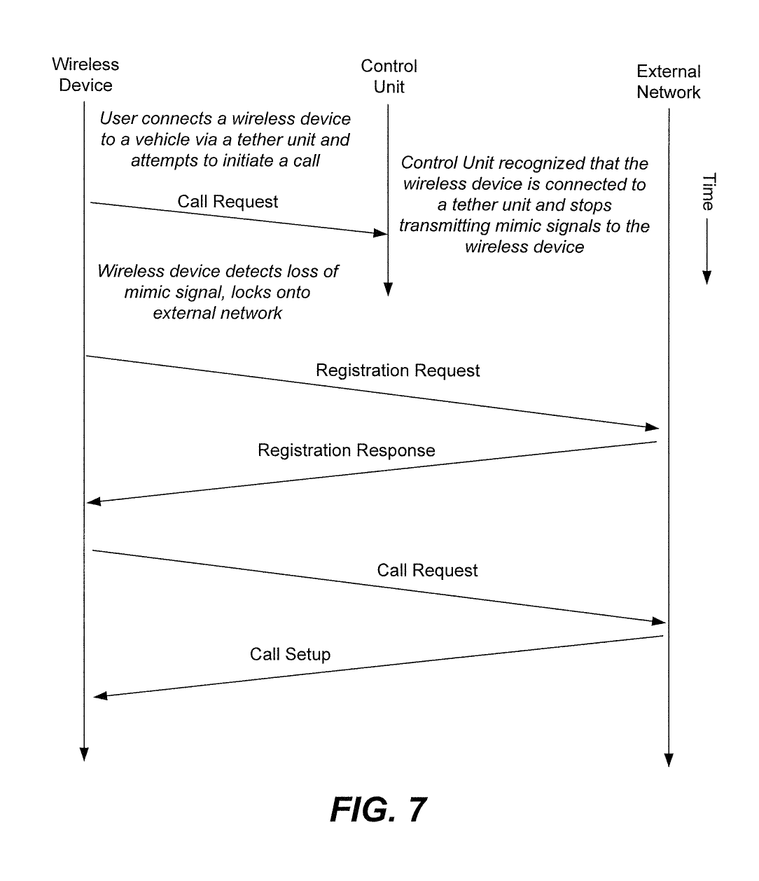

Various ways of implementing and operating the control unit 100 and the tether unit 300 together to selectively allow and restrict communication sessions are possible. FIG. 7 shows some such embodiments for allowing communications from tethered wireless units 104. The control unit can have previously registered the wireless unit, as shown in FIG. 2. A user may then attempt to initiate a call or other wireless transmission using the tethered wireless device. In response, the wireless device can send a call request to the control unit. The call request can include the identification data of the wireless device. The control unit can recognize the wireless device as being registered as a tethered device and, in response, stop transmitting mimic signals to the wireless device. Once the control unit stops transmitting mimic signals to the tethered wireless device, it is able to access an external wireless network 106 and initiate a wireless transmission thereby. Accordingly, the wireless device can send a registration request to an external wireless network 106. After a registration response is received, the wireless device can send a call request to the external wireless network and receive a call setup from that external network. This and other such protocol methods can be used to selectively allow communication sessions within an area (or particularly within a vehicle).

In some embodiments, the control unit 400 can be configured to recognize when a wireless device 104 is disconnected from a tether unit 300 or when the tether unit is disconnected from a tether connector 304. When this situation occurs, the control unit can again register with the wireless device and interrupt or terminate communication sessions engaged in by this wireless device. This protocol can reduce or eliminate the ability of users who uses a tether unit to initiate a communication session, then disconnects the tether unit to continue the communication session. Such a re-registration process can be similar to that illustrated in FIG. 2 and described herein.

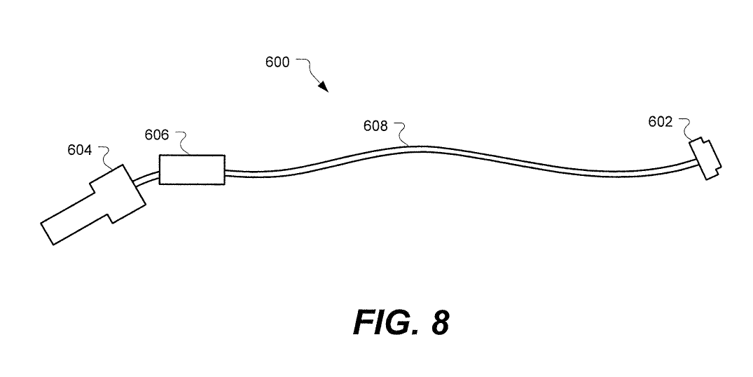

FIG. 8 depicts a tether unit 600 according to some embodiments that can be used in place of—or in addition to—the tether unit 300 of FIGS. 4 to 6. The tether unit 600 can include a wireless device connector 602 on a first end of a cable 608 and second connector 604 on a second end of the cable. The second connector 604 can be a vehicle connector when the tether unit is used in vehicles or a control unit connector when the tether unit is used without a vehicle. The cable 608 can have any of the lengths described herein. One or more electronic circuits 606 can also be associated with the tether unit. The electronic circuits can store, transmit, receive, process, and/or calculate the identification data of a wireless device, identification data of the tether unit, an indication of whether the tether is connected, and/or other related data. The tether unit and/or its connectors can be designed for various types and makes of wireless devices, vehicles, and/or control units.

While some embodiments of the devices and methods described above have used specific examples of particular messages and sequencing of messages between the control unit, wireless device, and external network, many other sequences and particular messages can be used to provide similar effects. For example, data messaging can be managed in a similar manner (e.g., disallowing transmission or reception of text messages when the vehicle is in motion). In another example, devices other than cellular telephones (e.g., personal data assistants, tablet computers, etc.) may provide capability to make telephone calls (e.g., through data networks such as “Wi-Fi” hot spots). Hence, it may prove useful to manage such types of communications as well. Accordingly, in some embodiments, the control unit can emulate a non-cellular data network (e.g., a data network, a WiMax network, and the like).

The systems and methods described herein can provide a number of useful features. First, by selectively blocking some types of telephone calls, communications in areas where calls are not permitted or desirable can be controlled (by eliminating or restricting such calls). Thus, security costs and measures may be reduced. In vehicles, distractions to a driver can be reduced which may, in turn, reduce the risk of accidents. Thus, insurance companies can offer discounts to drivers with these systems installed in their vehicles and employers may choose to install such systems to reduce their liability risk. A second feature is that since calls can be selectively enabled, risk of disruption of important emergency communications can be reduced or eliminated. This feature can help allow the Federal Communications Commission (or other governmental body) approve deployment of these systems.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A method of controlling use of a wireless device within a vehicle, comprising:
emitting a mimic signal from a controller located within a vehicle, the mimic signal having characteristics sufficiently similar to a wireless base station to cause a wireless device to register with the controller; and
receiving attempts to initiate wireless communication sessions from a wireless device within the vehicle by the controller; and
selectively allowing a wireless communications session between the wireless device and an external communications network when the wireless device is connected to the vehicle via a tether unit.

2. The method of claim 1, further comprising allowing the wireless communications session between the wireless device and the external network based on a predefined rule.

3. The method of claim 2, wherein the predefined rule comprises allowing wireless communications when the wireless device is calling an emergency number.

4. The method of claim 2, wherein the predefined rule comprises allowing wireless communications when the wireless device is calling a number on a predefined list of allowed numbers.

5. The method of claim 1, wherein the wireless communication session comprises a voice call.

6. The method of claim 1, wherein emitting the mimic signal comprises transmitting a paging channel from the controller.

7. The method of claim 1, wherein emitting the mimic signal comprises transmitting a plurality of signals corresponding to multiple cellular system types.

8. The method of claim 1, wherein selectively allowing wireless communication sessions comprises disabling transmission of the mimic signal.

9. The method of claim 1, wherein selectively allowing wireless communication sessions comprises transmitting a message to the wireless device to cause the wireless device to register with an external network.

10. The method of claim 1, wherein selectively allowing wireless communication sessions comprises:
exchanging messages with an external network to register the wireless device with the external network; and
sending a message to the wireless device to cause it to establish communication with the external network.

11. The method of claim 1, further comprising receiving from the wireless device via the tether unit unique identification data that identifies the wireless device.

12. The method of claim 11, wherein selectively allowing a wireless communications session between the wireless device and an external network comprises determining if the unique identification data of the wireless device matches the received unique identification data.

13. A control device for managing use of a wireless device within a vehicle, comprising:
a transmitter configured to emit a mimic signal having characteristics sufficiently similar to a wireless base station to cause a wireless device to register with the control device;
a receiver configured to receive data from the wireless device; and
a controller connected to the receiver, the transmitter, and to an interface of the vehicle;
wherein the controller is configured to respond to the receiver to receive attempts to establish a wireless communications session by the wireless device; and
wherein the transmitter is configured to respond to the controller to selectively establish a wireless communications session between the wireless device and an external network when the wireless device is connected to the vehicle interface via a tether unit.

14. The control device of claim 13, wherein the transmitter comprises a base station transmitter.

15. The control device of claim 14, wherein the transmitter transmits a waveform compliant with CDMA2000 waveform or UMTS waveform standards.

16. The control device of claim 13, wherein the receiver comprises a base station receiver.

17. The control device of claim 13, wherein the tether unit comprises a tether interface configured to receive identification data for the wireless device.

18. The control device of claim 17, wherein the tether unit is connected to the tether interface via a tether connector.

19. The control device of claim 18, wherein the tether unit comprises a cable having a first end and a second end, the first end having a wireless device connector and the second end having a connector configured to connect to the tether connector.

20. A tether unit for managing use of a wireless device within a vehicle, comprising:
a first connector adapted to be connected to a wireless device;
a second connected adapted to be connected to a portion of the vehicle; and
a tether interface configured to receive identification data for that wireless device that allows the wireless device to operate within the vehicle;
wherein the tether unit has a length sufficient to reach a passenger in the vehicle but not a length sufficient to reach the driver.
